(19) United States
(12) Patent Application Publication
(10) Pub. No.: US 2017/0362108 A1
(43) Pub. Date: Dec. 21, 2017

(54) HYBRID ACTIVATED IRON-BIOLOGICAL WATER TREATMENT SYSTEM AND METHOD

(71) Applicant: The Texas A&M University System, College Station, TX (US)

(72) Inventor: Yongheng Huang, College Station, TX (US)

(73) Assignee: The Texas A&M University System, College Station, TX (US)

(21) Appl. No.: 15/536,988

(22) PCT Filed: Dec. 18, 2015
(86) PCT No.: PCT/US2015/066847

§ 371 Date: Jun. 16, 2017

Related U.S. Application Data
(60) Provisional application No. 62/094,131, filed on Dec. 19, 2014.

(51) Int. Cl. C02F 3/00; C02F 3/30; C02F 3/34; C02F 3/28; C02F 103/18; C02F 103/16; C02F 103/36; C02F 103/06; C02F 103/00; C02F 101/22; C02F 101/20; C02F 101/16; C02F 101/10; C02F 103/10

(52) U.S. Cl. CPC C02F 3/006; C02F 3/2833; C02F 3/305; C02F 3/341; C02F 3/2806; C02F 2103/18; C02F 2103/16; C02F 2103/10; C02F 2103/06; C02F 2103/007; C02F 2101/22; C02F 2101/203; C02F 2101/163; C02F 2101/108; C02F 2101/103; C02F 2103/365; C02F 2209/04; C02F 2209/06; C02F 2305/06; C02F 2209/22

(57) ABSTRACT

A hybrid activated iron-biological treatment system and method for treating wastewater. The treatment system includes a combination of zero valent iron, ferrous iron, an iron oxide, and a denitrification microorganism.

### CROSS-REFERENCE TO RELATED APPLICATION

This application claims the benefit of Provisional Application No. 62/094131, filed Dec. 19, 2014, expressly incorporated herein by reference in its entirety.

### BACKGROUND OF THE INVENTION

Selenium has become a major concern for industrial wastewater treatment. The U.S. Environmental Protection Agency (USEPA) has imposed a strict discharge limit for selenium in flue gas desulfurization wastewater from coal-fired power plants, 10 ppb Se, effective in 2014. Selenium occurs in natural deposits and enters water bodies through discharge from mines, petroleum and metal refinery, and power plants. Selenium is considered as an essential trace element. However, selenium becomes toxic at levels greater than recommended. In the past, in response to the increasing concern of its toxic bioaccumulation in aquatic food chain, the USEPA established a freshwater criterion of 5 ppb Se and criteria for acute toxicity. Selenium exists mainly in several forms: selenate (Se^{VI}), selenite (Se^{IV}), elementary selenium (Se⁰), and selenide (Se^{II}). The oxyanions, SeO₄²⁻ and SeO₃²⁻, are most commonly found in wastewater.

Current selenium treatment technologies include ion exchange, adsorption-precipitation, reverse osmosis, biological reduction, zero-liquid-discharge (ZLD), and constructed wetlands, among others. Ion exchange and reverse osmosis remove both selenate and sulfate concurrently. To achieve a low ppb level Se, increased economics and fouling issues become limiting factors. Conventional adsorption-precipitation works efficiently merely for selenite that can be easily adsorbed to solid surfaces, while selenate has a low adsorption affinity.

Biological reduction technologies, represented by GE Water's ABMet™ and CH2MHill's ICB™ processes, utilize certain sulfate-reducing bacteria (SRB) to reduce mobile selenate to easily immobilized selenite or insoluble elemental Se⁰ under controlled reducing environments followed by removal. The application of these biological processes is constrained by high cost, process complexity, and other issues. To comply with the new low Se limit, the water industry is seeking a low-cost, reliable, and robust technology.

Despite the advances in the development of wastewater treatment systems, there is a need for cost-effective and reliable treatment systems having improved performance without disadvantages associated with undesirable byproducts. The present invention seeks to fulfill this need and provides further related advantages.

### SUMMARY OF THE INVENTION

The present invention provides hybrid activated iron-biological systems and methods for treating a contaminated fluid to remove or reduce the concentration of the contaminant in the fluid.

In one aspect, the invention provides a treatment system for removing or reducing the concentration of a contaminant in a fluid. In one embodiment, the system includes an activated iron (abiotic) component comprising a reactive solid comprising (a) zero-valent iron and one or more iron oxide minerals in contact therewith, and (b) ferrous iron, in combination with a biological (biotic) component comprising one or more denitrification microorganisms. In certain embodiments, the method further comprises activating the combination prior to contacting the combination with water. In certain of these embodiments, activating the combination includes (a) adding a denitrification microorganism to a combination of zero valent iron and ferrous iron, (b) adding a nutrient for the microorganism to the combination; and (c) incubating the combination in the presence of the nutrient for a predetermined time.

In certain embodiments, adding the microorganism includes adding a soil extract, such as an aqueous soil extract.

In certain embodiments, the microorganism is a bacterium, such as an anoxic bacterium. Representative microorganisms include Pseudomonas denitrificans, Pseudomonas aeruginosa, Pseudomonas perfectomarinus, Pseudomonas stutzeri, Pseudomonas aureofaciens, Pseudomonas mendocina, Pseudomonas fluorescens, Alcaligenes faecalis, Thiobacillus denitrificans, Paracoccos denitrificans (Micrococcus denitrificans), Microvirgula aerodenitrificans, and Thaurea mechernichensis. In the practice of the method, the denitrification microorganism may become attached to the zero valent iron or reactive solid.

In certain embodiments, the reactive solid is prepared by treating zero-valent iron with a solution that includes a dissolved oxidant and ferrous iron to provide a reactive solid comprising zero-valent iron and one or more iron oxide minerals in contact therewith. Suitable dissolved oxidants include nitrate.

In certain embodiments, the reactive solid comprises a plurality of particles. In certain embodiments, the one or more iron oxide minerals of the reactive solid include magnetite.

Contaminants that may be advantageously removed or reduced in concentration include metal compounds, metal ions, metalloids, oxyanions, chlorinated organic compounds, and combinations thereof. Representative contaminants that are effectively treated in the methods of the invention include nitrate and selenium species. Representative selenium species include selenate (Se⁶⁺), selenite (Se⁴⁺), and selenide (Se⁻²) species, as well as selenocyanate, selenomethionine, and methylselenic acid, and mixtures thereof.

The source of contaminated water treated by the methods of the invention can be varied, and include flue gas desulfurization wastewater, industrial waste stream, oil refinery waste, tail water of a mining operation, stripped sour water, surface water, ground water, and an influent stream. In certain embodiments, the contaminated water is flue gas desulfurization wastewater.

The methods of the invention can be carried out in a fluidized bed reactor.

In another aspect of the invention, a method for removing or reducing the concentration of a contaminant in a fluid is provided. In one embodiment, the method for removing or reducing the concentration of a contaminant in water comprises contacting water contaminated with one or more contaminants with an activated iron component in combination with a biological component for a time sufficient to remove or reduce the concentration of the contaminant in the water; the activated iron component comprising a zero valent iron composite comprising (a) a reactive solid comprising zero-valent iron and one or more iron oxide minerals in contact therewith, and (b) ferrous iron, and the biological component comprising one or more denitrification microorganisms.

In certain embodiments, the reactive solid is prepared by treating zero-valent iron with a solution that includes a dissolved oxidant and ferrous iron to provide a reactive solid comprising zero-valent iron and one or more iron oxide minerals in contact therewith. Suitable dissolved oxidants include nitrate.

In certain embodiments, the reactive solid comprises a plurality of particles. In certain embodiments, the one or more iron oxide minerals of the reactive solid include magnetite. In certain embodiments, the iron oxide is added iron oxide (externally added to the zero valent iron and ferrous iron mixture).

As noted above, in certain embodiments, the microorganism is a bacterium such as an anoxic bacterium. In certain embodiments, the system further includes a nutrient for the microorganism, such as a carbon-containing material, a phosphorus-containing material, a nitrogen-containing material, or a mixture thereof. In certain embodiments, the denitrification microorganism is attached to the zero valent iron or reactive solid particles.

In certain embodiments, the system is contained within a fluidized bed reactor.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 is a schematic illustration of a single-stage reactor system useful for carrying out a representative embodiment of the method of the invention.

FIG. 2 is a schematic illustration of a three-stage reactor system useful for carrying out a representative embodiment of the method of the invention.

FIG. 3 is a schematic illustration of a sequential biological denitrification and activated iron powder (AIP) flow-through batch reactors system useful for carrying out a representative embodiment of the method of the invention.

FIG. 4 illustrates nitrate removal in the biological denitrification reactor (R1) according to a representative embodiment of the method of the invention (acetic acid as carbon source, molar ratio of C/N=1.4; Fe²⁺ dosage=about 0.5 mM; HRT=4 hr).

FIG. 5 illustrates perchlorate removal and pH variation in the biological denitrification reactor (R1) according to a representative embodiment of the method of the invention (acetic acid as carbon source, molar ratio of C/N=1.4; Fe²⁺ dosage=about 0.5 M; HRT=4 hr).

FIG. 6 illustrates selenate removal in the biological denitrification reactor (R1) and AIP reactor (R2) according to a representative embodiment of the method of the invention (R1: acetic acid as carbon source, molar ratio of C/N=1.4; Fe²⁺ dosage=about 0.5 mM; R2: Fe²⁺ dosage=about 0.5 mM; HRT=4 hr for each reactor).

FIG. 7 illustrates Fe²⁺ consumption in the biological denitrification reactor (R1) and AIP reactor (R2) according to a representative embodiment of the method of the invention (R1: acetic acid as carbon source, molar ratio of C/N=1.4; Fe²⁺ dosage=about 0.5 mM; R2: Fe²⁺ dosage=about 0.5 mM; HRT=4 hr for each reactor).

FIG. 8 illustrates nitrate and ammonium concentration in the biological denitrification reactor (R1) when using methanol or glucose as carbon source according to a representative embodiment of the method of the invention or at control experiment (feed: synthetic groundwater, NO₃—N=about 30 mg/L; HRT=4 hr; methanol as carbon source: molar ratio of C/N=1.5, Fe²⁺ dosage=about 0.5 mM, pH in R1=6.9-8.3; glucose as carbon source: molar ratio of C/N=2, Fe²⁺ dosage=about 0.5 mM, pH in R1=7-9.2; control was conducted before denitrificans were introduced into R1 but after preconditioning, pH in R1=7-8.5, Fe²⁺=2.3 mM).

FIGS. 9A and 9B are scanning electron microscopy images (5000 times magnification) of solids in the biological denitrification reactor (R1) (9A) and AIP reactor (R2) (9B) collected after two-month operation of sequential flow-through system according to a representative embodiment of the invention (feed: synthetic groundwater at pH 7; carbon source: acetic acid; HRT=4 hr).

FIG. 10 compares X-ray diffraction (XRD) patterns of solids in the biological denitrification reactor (R1) and AIP reactor (R2) collected after two-month operation of sequential flow-through system according to a representative embodiment of the invention (feed: synthetic groundwater at pH 7; carbon source: acetic acid; HRT=4 hr; magnetite (min. 95%) was purchased from Strem Chemicals, Newburyport, Mass., USA).

### DETAILED DESCRIPTION OF THE INVENTION

The present invention provides systems and methods for treating a contaminated fluid to remove or reduce the concentration of the contaminant in the fluid.

In one aspect, the invention provides a treatment system for removing or reducing the concentration of a contaminant in a fluid. In one embodiment, the system includes an activated iron (abiotic) component comprising zero valent iron, ferrous iron (Fe(II) or Fe²⁻), and optional iron oxide (FeOx, for example, Fe₃O₄), in combination with a biological (biotic) component comprising one or more denitrification microorganism.

In certain embodiments, the system's zero valent iron comprises zero valent iron having one or more iron oxide minerals (FeOx) in contact therewith. Representative iron oxide minerals include magnetite. In certain embodiments, iron oxide is generated by a reaction of the zero valent iron and ferrous iron. In other embodiments, the iron oxide is an added iron oxide (i.e., added to the system as a separate component). Magnetite is a representative iron oxide useful in the system of the invention.

The system of the invention includes one or more denitrification microorganisms. Denitrification microorganisms useful in the system and methods of the invention are effective in converting nitrate to nitrogen gas. Denitrification microorganisms are ubiquitous in the environment and can readily be obtained and selectively cultured from soil samples (e.g., dirt). Suitable denitrification microorganisms include bacteria, such as anoxic or anaerobic bacteria. Representative denitrification microorganisms are described below.

To facilitate the growth and sustainability of the microorganism in the system, one or more nutrients for the microorganism can be added to the system. Suitable nutrients include carbon-containing materials, phosphorus-containing materials, and nitrogen-containing materials. Representative carbon-containing materials include sugars (e.g., glucose) and organic acids (e.g., acetic acid). A representative nitrogen-containing material is nitrate, which is present as a contaminant in many industrial waste streams and thereby is effective for selectively growing nitrate-reducing microorganisms in the system. In certain embodiments, the ratio of carbon-containing material to nitrogen-containing material is about 1:1.

The system of the invention can be embodied in a fluidized bed reactor.

In another aspect of the invention, a method for removing or reducing the concentration of a contaminant in a fluid is provided. In one embodiment, the method for removing or reducing the concentration of a contaminant in water comprises contacting water contaminated with one or more contaminants with an activated iron component in combination with a biological component for a time sufficient to remove or reduce the concentration of the contaminant in the water; the activated iron component comprising zero valent iron, ferrous iron, and optional iron oxide, and the biological component comprising a denitrification microorganism. In certain embodiments, the method for removing or reducing the concentration of a contaminant in water comprises contacting water contaminated with one or more contaminants with the system of the invention.

In certain embodiments, the combination of zero valent iron, ferrous iron, and optional iron oxide are activated prior to contact with the contaminated water. In one embodiment, activating the combination comprises reacting the combination of zero valent iron, ferrous iron, and optional iron oxide with a material to be reduced (e.g., nitrate) for a predetermined time. The period of time can be varied and is generally the period of time necessary to provide the quantity of highly reducing activated iron depending on the sample to be decontaminated. In another embodiment, activating the combination comprises adding a denitrification microorganism to a combination of zero valent iron, ferrous iron, and optional iron oxide, adding a nutrient for the microorganism to the combination; and incubating the combination of the denitrification microorganism, zero valent iron, ferrous iron, and optional iron oxide in the presence of the nutrient for a predetermined time. The period of time can be varied and is generally the period of time necessary to provide the concentration of microorganism sufficient for contaminate removal. For example, a three day incubation period was found sufficient to accumulate adequate denitrification bacteria to achieve over 90% biological nitrate reduction of 30 mg/L as N within a treatment time of 4 hr. Microorganism concentration can be monitored by nitrate nutrient consumption and/or nitrogen production. Utilization of nitrate as nutrient selectively cultures nitrate reducing microorganisms.

In one embodiment, the one or more microorganisms are added to the system as a soil sample or as an aqueous soil extract.

The method of the invention can be carried out in a fluidized bed reactor.

The systems and methods are robust, flexible, and based on cost-effective materials. For example, systems and methods of the invention may cost-effectively treat all major pollutants in flue gas desulfurization (FGD) wastewater in a single process. In some embodiments, a fluidized reacting system is provided that uses the system to remove many toxic metals and nitrates from a contaminated fluid. In addition to removing toxic metals and nitrates, the systems and methods can remove oxyanion pollutants and metalloids as well as dissolved silica. Typically, methods can be performed at ambient temperature, atmospheric pressure, and near neutral pH. The systems and methods of the invention not only retain or enhance the advantages and capacities of the activated iron systems, but also includes features and unique capabilities of biological wastewater treatment systems.

In certain aspects, the systems and methods of the invention expand the capabilities of zero valent iron (ZVI) systems including the hybrid ZVI/FeOx/Fe(II) treatment systems described in US 2011/0174743 and US 2012/0273431. The systems and methods of the invention also improve and expand the capabilities of biological treatment systems (e.g., General Electric's ABMet® system).

One advantage of the hybrid activated iron biological system in the treatment of industrial waste streams contaminated with nitrate and heavy metals is that the system's microorganism can contribute to nearly complete removal of nitrate through the biological denitrification process, while the system's activated iron can nearly completely remove heavy metals (e.g., selenium, mercury, arsenic species) through reduction and immobilization.

There are several advantages associated with the removal of nitrate through denitrification.

First, through the advantageous use of denitrifying microorganisms, the system and methods of the invention consume dissolved oxygen and organic materials, such as organic contaminants present in certain waste streams (e.g., chlorinated organic compounds), and produce nitrogen, not ammonia, from nitrate. The production of nitrogen rather than ammonia is an obvious and significant advantage over simple activated iron systems.

Second, because the denitrifying microorganisms are effective in removing nitrate from these wastewaters, the activated iron is not consumed by nitrate or dissolved oxygen and is therefore available for reduction and removal of the remaining contaminants, such as heavy metals and metalloids. The presence of the microorganisms thereby effectively increases the lifetime of the activated iron component. The effectiveness of the activated iron in microorganism-containing systems and methods can be increased from weeks/months to a year or more.

Third, when microorganisms attach to zero valent iron grains (particles) in the system and grow, metabolism steps/pathways assist in maintaining a magnetite-containing surface on the zero valent iron, which is conducive for achieving high electron and ion conductivity for the zero valent iron corrosion layer. The large reactive iron surface and iron species may also be beneficial to certain microbial metabolisms.

Hybrid Activated Iron-Biological Treatment Systems

The hybrid activated iron-biological treatment system of the invention includes a zero valent iron composite in combination with one or more denitrification microorganisms.

Zero valent iron composites. A zero valent iron [ZVI/FeOx/Fe(II)] composite (also referred to as a hybrid zero valent iron composite or hybrid ZVI composite) includes a reactive solid [zero valent iron (ZVI) and iron oxide (FeOx)] and a secondary reagent [ferrous iron (Fe(II) or Fe²⁺)]. The reactive solid may be transformed into a reactive material effective for removing and/or reducing the concentration of contaminants in a fluid. The composite is a particle having a core comprising zero-valent iron and a layer associated with the core that includes the reactive material.

An advantage of the hybrid ZVI composite is the sustainability of a high level of activity and improved lifetime, particularly in comparison to compositions or systems that include zero valent iron alone.

The reactive composite can be produced by an activation process. The activation process may involve oxidizing at least a portion of a zero-valent iron so as to form an iron oxide and exposing the iron oxide to dissolved ferrous ion to form the reactive material. The ferrous ion may adsorb onto and become a part of the composite. As described herein, the reactive composite may be produced in situ as part of a contaminant removal process.

Hybrid zero valent iron treatment systems that utilize hybrid ZVI composites are described in US 2011/0174743 and US 2012/0273431, each expressly incorporated by reference in its entirety.

Zero valent iron (ZVI, Fe(0)) may be employed in the form of a particle or a plurality of particles (e.g., a powder). Such powders are commercially available (e.g., Hepure Technology, Inc.). No specific high purity of the particles is required: purities greater than about 95% may be employed.

Particle sizes, average particle sizes, or particle size distribution of zero valent iron may vary. For example, particles may be less than 50 microns in size. Particles may range from about 5-50 microns in size. Particles may have a distribution of about 45-150 microns, wherein the predominant distribution is 60-100 microns.

Ferrous iron (Fe(II) or Fe²⁺) in the system may exist in various forms: dissolved Fe²⁺ (including levels of FeOH⁺ and Fe(OH)₂ at near neutral pH), surface-bound Fe(II) (adsorbed or precipitated, generally reactive), and incorporated reactive Fe(II) (e.g., the Fe(II) in the non-stoichiometric Fe₃O₄), and structural non-reactive Fe(II) (such as Fe(II) in aged Fe₃O₄). Some embodiments may entail more than one type of ferrous iron.

A variety of sources may supply ferrous iron. In some embodiments, FeCl₂ is the source of ferrous iron. In some embodiments, FeSO₄ is the source. FeCl₂ and FeSO₄ are widely available and generally inexpensive in comparison to other ferrous iron sources. Other examples include ferrous bromide and ferrous nitrate. One may also generate Fe²⁺ in situ in a separate reactor: for example, one may add strong acids (such as HCl, H₂SO₄, or HNO₃) to dissolve Fe(0) or FeCO₃ to provide Fe²⁺. Persons of skill in the art are familiar with sources of ferrous iron.

In general, ferrous iron is disposed so as to facilitate maintenance of the iron oxide mineral included in a composite, and wherein the composite is active for removing a contaminant from a fluid. Ferrous iron may be present as Fe²⁺ dissolved in an aqueous solution, such as an acidified aqueous solution. Adding small concentration of a strong acid (e.g., less than 10 mM HCl, such as 5 mM HCl) helps stabilize the solution. In a non-acidified Fe²⁺ solution, hydrolysis of Fe²⁺ may occur, which will form Fe(OH)₂ floc and be oxidized to form iron oxide precipitate. In some embodiments, ferrous iron is present as surface-bound Fe(II), such as bound to the surface of an iron oxide mineral. Fe(II) may be incorporated into reactive solids.

Some embodiments described herein, such as contaminant-removal processes, may be performed at near neutral pH. The pH may be between 6 and 8. The pH may be between 7 and 8. In some embodiments, a pH of 6.5-7.5 is maintained. In some embodiments, a pH of 6.8-7.2 is maintained, such as in a fluidized zone. In some embodiments, a pH of 7.0-7.5 is maintained.

Once a system is successfully started up, the system requires only low-level maintenance effort. Routine operation and maintenance with respect to pH control are described, for example, in US 2011/01747443 and US 2012/027343, each expressly incorporated herein by reference in its entirety.

Microorganisms. Denitrification is the process where nitrates are reduced to gaseous nitrogen by organisms. Microorganisms that carry out the process are denitrifying microorganisms.

Denitrifying microorganisms can include denitrifying bacteria, which can metabolize nitrogenous compounds with the assistance of a nitrate reductase enzyme, thereby reducing nitrates to nitrogen gas or nitrous oxides. Denitrification occurs in the absence of oxygen, as most denitrifying bacteria preferentially use oxygen as their terminal electron acceptors rather than nitrate. Thus, in some embodiments, the denitrification microorganisms can include anoxic or anaerobic bacteria.

The denitrification process can occur via the reaction below (Eq. 1), where the nitrate is converted to gaseous nitrogen:

2NO₃⁻+10 e⁻+12H⁻→N₂+6H₂O (1)

Denitrification bacteria include several species of Pseudomonas, Alcaligenes, and Bacillus. Non-limiting examples of denitrification bacteria include Pseudomonas denitrificans, Pseudomonas aeruginosa, Pseudomonas perfectomarinus, Pseudomonas stutzeri, Pseudomonas aureofaciens, Pseudomonas mendocina, Pseudomonas fluorescens, Alcaligenes faecalis, Thiobacillus denitrificans, Paracoccos denitrificans (Micrococcus denitrificans), Microvirgula aerodenitrificans, and Thaurea mechernichensis.

To generate a hybrid activated iron-biological treatment system, denitrification microorganisms can be seeded into a reactor that includes the abiotic iron component. The seeded reactor that includes zero valent iron or activated iron component can be provided with nutrients (e.g., carbon, nitrogen, and phosphorus sources; micronutrients; and/or vitamins) and incubated for an amount of time sufficient to generate a desired population of microorganisms.

Seeding can be accomplished, for example, by adding to a reactor that includes a zero valent iron composite a culture of one or more microorganism(s), or by adding a liquid soil extract that includes a suspension of soil microorganisms.

In some embodiments, carbon-based nutrients include sugars (e.g., glucose, sucrose), certain alcohols (e.g., ethanol), and organic acids (e.g., acetic acid, acetate, butyrate) that support the microorganisms' metabolic and growth needs. Examples of nitrogen-based nutrients can include urea, ammonia nitrate, and sodium nitrate. Examples of micronutrients include Ca, K, Mg, Cu, Zn, Se, Fe, Mo, and B. Examples of vitamins include folic acid, biotin, and vitamins B1 and B12.

Hybrid activated iron-biological treatment system characteristics. In the hybrid activated iron-biological treatment system of the invention, the microorganisms can contribute to organic material removal as well as nitrate removal through a biological denitrification process, while the zero valent iron composite can remove toxic metals from the wastewater.

The zero valent iron composite and the microorganisms of the system can be mutually beneficial. As noted above, the microorganisms can consume organic matters, rapidly reduce dissolved oxygen, and convert nitrates into nitrogen gas, thereby decreasing the consumption of the zero valent iron composite that may otherwise be used to reduce dissolved oxygen and nitrates. Thus, the zero valent iron composite can be used primarily for reacting with contaminants and the lifespan of the zero valent iron composite can be significantly extended. The zero valent iron composite can create a low-oxygen, reducing, and near-neutral chemical environment favorable for certain microorganisms (e.g., denitrification bacteria), while microorganisms attached to a zero valent iron grain or activated iron grain assist in maintaining a magnetite surface on the grain surface.

The zero valent iron composite can create a robust, stable and consistent aquatic environment that facilitates the growth and maintenance of a consortium of microorganisms and a healthy micro-ecosystem. For example, in an anaerobic (reducing) environment, Fe(III) can serve as a terminal electron acceptor and various microorganisms can reduce Fe(III) to Fe(II). The large reactive iron surface or iron species can be beneficial to certain microbial metabolisms. In some embodiments, control of soluble Fe²⁺ level and other variables (e.g., pH) in a zero valent iron composite can regulate the oxidation-reduction potential in the hybrid chemical-biological treatment system, which can dictate the metabolism pathways of microorganisms. For example, by limiting the concentration of dissolved Fe²⁺, the oxidation-reduction potential in a hybrid chemical-biological treatment system can be increased, thereby suppressing the activity of sulfate-reducing bacteria.

In conventional biological treatment systems (e.g., General Electric's ABMet® system), odor can result from the generation and release of hydrogen sulfide (H₂S) from microbial anaerobic metabolism. However, in the hybrid activated iron-biological treatment system of the present invention, sulfide generated from biological process can be rapidly immobilized by reaction with Fe²⁺ resulting in precipitation. Alternatively or additionally, the sulfide can be adsorbed or precipitated onto a magnetite surface, and/or be incorporated as sulfide (S²⁻) into iron oxide minerals. Thus, the hybrid activated iron-biological treatment system can be relatively odorless, compared to conventional biological treatment systems.

In a hybrid chemical-biological treatment system, the amount of spent solid waste (e.g., spent microorganisms and spent zero valent iron composite) can be reduced compared to a chemical treatment system. The denitrification microorganisms can be relatively robust (e.g., when compared to a selenite-reducing bacteria), as denitrification microorganisms can be found in natural environments and can withstand demanding working conditions.

In operation, microorganisms in association with the zero valent iron composite can be suspended within fluidizing reactors for wastewater treatment. The fluidizing reactor can provide for efficient mass transfer, which can promote the reaction rate or metabolism rate of microorganisms, and thereby achieve higher removal efficiency than a conventional attached-growth biofilm system (e.g., General Electric's ABMet® system).

The hybrid activated iron-biological treatment system can be used in a variety of applications, as microorganisms having different capabilities can be hosted by the zero valent iron composite. For example, the system may be suitable for treating wastewater with certain recalcitrant organic contaminants. In some embodiments, chlorinated organic compounds can be de-chlorinated by the activated iron component and can then be more readily further broken down or taken up by microorganisms.

Hybrid activated iron-biological treatment system operation. In the hybrid activated iron-biological treatment system of the invention, nitrate is converted to nitrogen. This is accomplished by controlling or reducing dissolved oxygen in the reactor to achieve anoxic conditions in order for the microorganisms to consume nitrate as their oxygen source. Nitrogen can then be removed by aeration. The process can be controlled by measuring oxidation reduction potential (ORP) and by adjusting aeration.

Treatable Contaminated Fluids

A variety of fluids may be treated according to embodiments discussed herein. Fluids to be treated typically include a contaminant, such as a toxic material (e.g., a toxic metal or metalloid). A fluid may include a fluid stream. A fluid stream may include a waste stream. A fluid may be aqueous, such as wastewater. A fluid may include an aqueous stream. A fluid may include an influent stream. A fluid may include an industrial waste stream. “Industrial waste stream” refers to liquid streams of various industrial processes. An industrial waste stream may be produced at any stage of a process. A waste stream may be wastewater, which herein refers to a primarily water-based liquid stream. Wastewater may be synthetic or simulated wastewater. A fluid may be flue gas desulfurization (FGD) wastewater. A fluid waste may include oil refinery waste. A fluid may be tail water of a mining operation. A fluid may include stripped sour water. The aqueous fluid may include a suspension. Other examples of fluids include tap water, deionized water, surface water, and groundwater. Wetlands may include a fluid. A fluid may be an influent stream. A fluid may have a near-neutral pH. A fluid may have a substantially neutral pH. A fluid may have a pH between 6 and 8. A fluid may include an oxidant or other additive, as discussed herein.

Various treatment flow rates may be employed. In some embodiments, flow rate is about, at most about, or at least about 50, 100, 200, 300, 400, 500, 600, 700, 800, 900, or 1000 gallons per minute (gpm), or more, or any range derivable therein. In some embodiments, fluid is treated at a rate ranging up to about 1000 gpm, such as in embodiments regarding treating FGD streams, such as in the context of power plant operation. In some embodiments, fluid is treated at a rate ranging up to and including 600 gpm, such as in embodiments regarding treating stripped sour water in the context of refinery plant operation.

Contaminants and Contaminant Removal

A variety of contaminants may be removed from a contaminated fluid using embodiments discussed herein. Contaminants that can be removed or their concentration reduced include metal compounds, metal ions, metal oxides, metalloids, oxyanions, chlorinated organic compounds, or combinations thereof.

The contaminant may be a toxic metal. Toxic metals exist in various dissolved forms (e.g., metal ions or various oxyanions). In FGD wastewater, for example, Hg²⁺ is the main concern. Similarly, Cu and Zn may exist as metal ions (Cu²⁺ and Zn²⁺). For Se, selenate (SeO₄²⁻) may be present in greatest quantities, but selenite (SeO₃²⁻) or selenocyanate (SeCN⁻) may be present. Arsenic may exist as arsenate (AsO₄³⁻) or arsenite (AsO₃³⁻). Chromium may exist as chromate (CrO₄⁻). One or more of these ions may be considered a contaminant. Persons of skill in the art are familiar with the types of toxic metals that exist in contaminated fluids.

According to some embodiments, toxic metals are encapsulated within iron oxide crystalline (mainly magnetite powder) that are chemically inert and physically dense for easier solid-liquid separation and final disposal. Contaminants may be removed as precipitates. The contaminant may be reduced and then removed, such as when the contaminant is selenate, which may be reduced by employing methods described herein to selenite, which may be further reduced to elemental selenium and removed. As another example, iodate or periodate may be reduced to iodide by employing methods described herein.

Examples of contaminants include toxic materials, such as toxic metals. Non-limiting examples of toxic metals include arsenic, aluminum, antimony, beryllium, mercury, selenium, cobalt, lead, cadmium, chromium, silver, zinc, nickel, molybdenum, thallium, vanadium, and the like, ions thereof, and compounds thereof. Metalloid pollutants are also contemplated as contaminants, such as boron and the like, and ions thereof.

The contaminant may include oxyanion pollutants, such borates, nitrates, bromates, iodate, and periodates, and the like.

Combinations of contaminants are also contemplated, such as combinations of arsenic, mercury, selenium, cobalt, lead, cadmium, chromium, silver, zinc, nickel, molybdenum, and the like, and ions thereof; metalloid pollutants such as boron and the like and ions thereof; and oxyanion pollutants, such as nitrate, bromate, iodate, and periodate, and the like. Alternatively or in combination, the contaminant may be dissolved silica. The contaminant may be a nitrite or a phosphate. A contaminant may be selenium or selenate. The contaminant may be hexavalent selenium. The contaminant may be copper (e.g., Cu²⁺ or Cu⁺). The contaminant may be a radionuclide.

The contaminant may be a chlorinated organic compound. The use of zero valent iron to treat chlorinated organics has been practiced in environmental remediation in the past. The known practices involve using zero valent iron as reactive media to build underground permeable reactive barriers to treat trichloroethylene (TCE) plumes in contaminated ground water. Zero valent iron as a reductant may react with these halogenated compounds and remove chlorine from the molecule (dechlorination). Some embodiments disclosed herein employ above-ground fluidized bed zero valent iron reactors to treat fluids contaminated with chlorinated organic compounds such as TCE.

More than one contaminant may be removed or reduced in concentration at the same time (e.g., simultaneously, or in the same reactor, or in the presence of a single reactive zone). In some embodiments, removing or reducing the concentration of a contaminant includes exposing a fluid including a contaminant to a treatment system that includes a zero valent iron, ferrous iron, an iron oxide (i.e., a zero valent iron composite); and an added denitrification microorganism for a sufficient amount of time to remove or reduce a concentration of the contaminant in the fluid.

Reductions in contaminant concentration may be achieved by employing embodiments described herein. For example, the reduction in contaminant concentration may be greater than 70%. The reduction in contaminant concentration may be greater than 80%. The reduction in contaminant concentration may be greater than 90%.

Representative contaminants that can be removed or their concentration reduced include arsenic compounds, aluminum compounds, antimony compounds, beryllium compounds, mercury compounds, selenium compounds, cobalt compounds, lead compounds, cadmium compounds, chromium compounds, silver compounds, zinc compounds, nickel compounds, molybdenum compounds, thallium compounds, vanadium compounds, arsenic ion, aluminum ion, antimony ion, beryllium ion, mercury ion, selenium ion, cobalt ion, lead ion, cadmium ion, chromium ion, silver ion, zinc ion, nickel ion, molybdenum ion, thallium ion, vanadium ion, borates, nitrates, bromates, iodates, periodates, trichloroethylene, dissolved silica, and combinations thereof.

Reactor Systems

Exemplary reactor systems useful in the methods of the invention include those described in US 2011/01747443 and US 2012/027343, each expressly incorporated herein by reference in its entirety. Single-stage and multiple-stage reactor systems can be used.

In some embodiments, the system is a single-stage reactor system and includes a single reactor (e.g., a fluidized bed reactor). In other embodiments, the system is a multiple-stage reactor system and includes two or more reactors. The systems may further include one or more of the following: an internal solid/liquid separating zone (e.g., settling zone), an aerating basin, a settling basin, and a filtration bed.

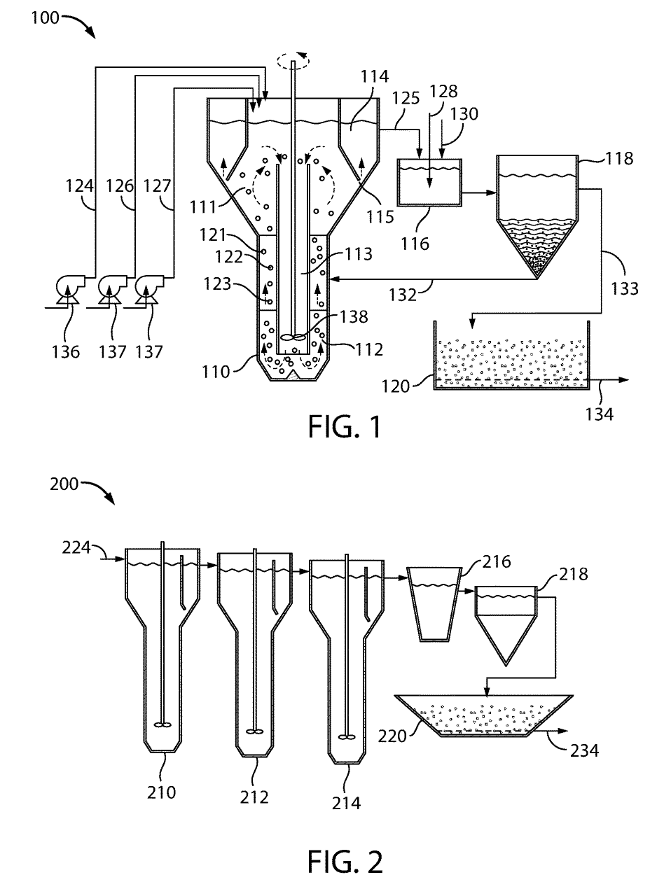

A representative single-stage reactive system useful for carrying out the methods of the invention is schematically illustrated in FIG. 1. Referring to FIG. 1, reactor system 100 includes reactor 110 having reactive zone 111 in fluid communication with internal settling zone 114. In certain embodiments, reactive zone 111 is maintained near neutral pH. In certain embodiments, settling zone 114 uses gravitational forces to separate solids from liquids. In certain embodiments, settling zone 114 is positioned towards the top of reactor 110 (as shown in FIG. 1). Communication between settling zone 114 and reactive zone 111 is via inlet 115. Effluent 125 is removed from the top region of settling zone 114 to aerating basin 116.

Reactor 110 includes central conduit 113, which provides mixing (e.g., convection motion).

In certain embodiments, reactor 110 operates in part as fluidized bed reactor that employs motorized stirrer 138 in conjunction with central conduit 113 to create circular flow within reactor 110 and provides mixing between wastewater 124 and solid particles 121 (activated iron particles), 122 (activated iron particles with associated microorganisms), and 123 (microorganisms). Settling zone 114 provides for solid-liquid separation and return of the solid into fluidized zone 112. As used herein, the term “fluidized bed reactor” refers to a reactor that provides a flow of reactive solids (e.g., 121, 122, and 123) within the reactor so as to provide mixing between the solids and wastewater to facilitate reaction. In certain embodiments, the reactor includes a stirrer and operates as a stirred tank reactor. Flow within the reactor can be established by conventional methods known in the art for creating flow in a fluidized bed reactor. As shown in FIG. 1, single-stage reactor system 100 includes fluidized zone 112, internal settling zone 114, aerating basin 116, settling basin 118, and sand filtration bed 120.

Within the reactor, fluidized zone 112 is the primary reactive space where solids 121, 122, and 123 in the form of particles (including denitrifying microorganisms) are mixed with wastewater 124 and secondary reagent 126, and where various physical-chemical and biological processes responsible for toxic metal and nitrates removal occur.

Settling zone 114 allows particles and denitrifying microorganisms to separate from water and be returned in fluidized zone 112. For high density particles, an internal settling zone with a short hydraulic retention time is sufficient for complete solid/liquid separation. This eliminates the need of a large external clarifier and a sludge recycling system.

Aerating basin 116 serves at least two purposes: (1) to eliminate residual secondary reagent in effluent 125 from fluidized zone 112; and (2) to increase the dissolved oxygen level. For a single-stage reactor, effluent from the fluidized zone will typically contain a certain amount of secondary reagent. Oxidation of secondary reagent will consume alkalinity and therefore will lower the pH. In some embodiments, to accelerate oxidation of secondary reagent, aerating basin 116 is maintained at a pH of above 7.0. Chemicals such as Ca(OH)₂, NaOH, and Na₂CO₃ may be used for pH control.

Settling basin 118 serves to remove flocculent formed in aerating basin 116. Flocculent that has settled to the bottom of basin 118 can be returned as sludge 132 to fluidized zone 112 and transformed by secondary reagent 126 into dense particulate reactive solid.

Sand filtration bed 120 can be used to further polish intermediate treated water 133 before discharge as treated water 134.

Post-reactor stages (e.g., aeration-settling-filtration) may not be needed under certain system operating conditions.

Referring to FIG. 1, the system can further include wastewater pump 136, reagent pumps 137, auxiliary reagent 127 (e.g., HCl), air 128, and pH control chemical 130.

A representative three-stage reactive system useful for carrying out the methods of the invention is schematically illustrated in FIG. 2. Referring to FIG. 2, reactors 210, 212, and 214 (e.g., fluidized bed reactors) are combined to provide multi-stage treatment system 200. In certain embodiments, each reactor (i.e., stage) maintains its own reactive solid and/or denitrifying microorganism. That is, the solids are separated in each stage. In order to achieve a separate solid system, each stage may have its own internal solid-liquid separation structure (e.g., such as settling zone 114 as shown in FIG. 1).

Depending on operating conditions in reactors 210, 212, and 214, wastewater 224 characteristics, and discharge 234 standards, post-reactor stages (aeration 216, settling basin 218, filtration bed 220) may not be necessary. Although a multi-stage reactor system is more complex and may result in a higher initial construction cost, a multi-stage reactor system can have several advantages.

A multi-stage system can achieve higher removal efficiency than a single-stage system under comparable conditions. Further, the FGD wastewater may contain certain chemicals (e.g., phosphate and dissolved silica) detrimental to the reactivity of the solids. A multi-stage system may intercept and transform these chemicals in the first stage and thus reduce the subsequent stages to the negative impact of the detrimental chemicals. As such, a multi-stage configuration can be more stable and robust.

A multi-stage configuration facilitates the control of nitrate reduction. In a single-stage system, because of the presence of dissolved oxygen in raw wastewater, operating the system in a rigorous anaerobic environment is difficult. In a multi-stage system, the first stage can effectively remove virtually all dissolved oxygen and, as a result, subsequent stages can be operated under a rigorous anaerobic environment.

A multi-stage system also allows for flexible control of different chemical conditions in each individual reactor. The chemical conditions in each reactor can be controlled by adjusting the pumping rate of supplemental chemicals and adjusting aeration. A multi-stage system can be operated in a mode of multiple feeding points. Each stage can be operated under different pH and dissolved oxygen conditions.

A multi-stage system will typically lower chemical consumption. In a single-stage complete-mixed system, secondary reagent in the reactor is desirably maintained at a relatively high concentration in order to maintain high reactivity of reactive solids. As a result, residual secondary reagent in the effluent will be high. This means that more secondary reagent will be wasted and more neutralizer (e.g., NaOH or lime) consumption will be required to neutralize and precipitate the residual secondary reagent in the effluent. As a result, more solid sludge will be produced and waste disposal cost will increase. In a multi-stage system, residual secondary reagent from the first stage can be used in the second stage. In this case, secondary reagent may be added in a way that conforms to its actual consumption rate in each stage. As a result, it is possible to control residual secondary reagent in the effluent in the final stage to be much lower than the one in a single-stage system.

The evaluation of a representative hybrid activated iron-biological treatment system is described below.

A sequential biological denitrification and activated iron powder (AIP) flow-through reactor system is described below. The system eliminates the production of ammonium during the AIP treatment of nitrate by removing nitrate with a biological denitrification process, while maintaining the chemical reducing capability of AIP to selenate. In this denitrificans/ZVI/magnetite/Fe²⁺ system, nitrate was reduced to nitrogen by 99% through a 4-hr HRT biological denitrification and selenate was reduced from 3 ppm to about 50 ppb Se after a 2-stage 8-hr HRT AIP treatment. Acetic acid was determined to be the optimal carbon source for this specific reducing environment and the ratio of C to N was 1.4. The yield of cell growth was low at 0.07 g biomass/g NO₃⁻—N. Excess biomass build-up showed inhibition on selenate reduction and the solids in reactors required a routine wash to achieve a high Se removal efficiency. The system and related method may be developed into a practicable wastewater treatment technology.

### Representative Hybrid Activated Iron-Biological Treatment System

A zero valent iron composite reactor having low or no dissolved oxygen and a low oxidation-reduction potential can create an environment that is suitable for various microorganisms to enter into anoxic or anaerobic metabolisms. The zero valent iron composite system is operated at near-neutral pH values, and is adapted to buffer normal pH disruption or variation in industrial application environments and creates a favorable pH environment for microorganisms to grow and multiply. The high concentration of activated iron particles (magnetite-coated zero valent iron particles and individual or aggregated magnetite particles) provides a large surface area onto which microorganisms can attach and grow. The reactor design described below can achieve efficient separation of solids and liquids, particularly in the presence of heavy activated iron sludge that forms a thick blanket at the bottom of the internal settling zone which filters out in a discrete or aggregate form while decreasing the loss of microorganisms.

A bench-top continuous-flow treatment system was made and tested. Microorganisms were successfully cultivated in a zero valent iron composite reactor to generate a hybrid chemical-biological treatment system. Microorganisms in the hybrid activated iron-biological treatment system effectively reduced nitrate in the water to nitrogen gas. For example, a single-stage system was found to reduce 30 mg/L nitrate-nitrogen in the feed water to below 0.1 mg/L at a hydraulic retention time (HRT) of 4 hour. Almost all (>99%) nitrate-nitrogen was converted directly to nitrogen (N₂). In comparison, in an activated iron system without microorganisms, nitrate would be fully converted by the activated iron into ammonia, which may need to be further chemically treated (e.g., using chlorine to oxidize ammonia to nitrogen) if there is a discharge limit for ammonia. Selenate reduction was not affected by the presence of microorganisms.

In a two-stage system, nitrate was completely reduced from 30 mg/L to <0.1 mg/L in stage 1, and selenate was simultaneously reduced from 3.5 mg/L to about 1.0 mg/L in the first stage with 4 h reaction time. In the second stage, selenate was further reduced to below 0.02 mg/L. While nitrate reduction appeared to be dominated by biological denitrification process, both microorganisms (certain selenate-reducing microorganisms) and activated iron may contribute to selenate reduction from water. At the second stage, activated iron may play a major role in selenate reduction, but it is possible that more selenate-reducing bacteria may accrue in the system under more favorable conditions over time and eventually contribute to the overall selenite reduction.

A small amount of sulfate (3-6 mg/L reduction out of 22 mg/L in the feed) was also reduced. Reduction of sulfate by sulfate-reducing microorganisms into hydrogen sulfide (H₂S) is a major problem for conventional biological selenate-removing technologies (e.g., General Electric's ABMet® technology and CH2MHill's iBio technology) because hydrogen sulfide is a serious environmental and health hazard. In the hybrid activated iron system, no hydrogen sulfide release was observed despite evidence of biological sulfate reducing activities. The gas that bubbled from the system reactor, which was collected and analyzed, consisted of mostly (>90%) N₂ and some CO₂, but not H₂S. Thus, the small amount of sulfide generated by the sulfate-reducing bacteria was likely removed by the high concentration of activated irons in a zero valent iron composite by forming FeS precipitate and minerals.

To convert an activated iron system into a hybrid activated iron-biological system, the reactors are seeded with microorganisms and fed with biological nutrients (carbon, nitrogen, and phosphorus sources as well as other micronutrients). Seeding could be accomplished by adding soil (e.g., garden top soil rich of organic matters) extracted liquid into the reactors. Glucose, sugar, and/or methanol could be used as carbon sources to support microorganisms' needs in metabolism and growth. In the laboratory bench-top continuous-flow treatment system, microorganisms (denitrification bacteria) were successfully developed in 5 days when the complete denitrification of 30 mg/L nitrate-N to nitrogen gas was achieved with a reaction time of 4 h. A carbon to nitrogen ratio of about 1:1 was found sufficient to support the biological denitrification process.

### Representative Sequential Biological Denitrification and Activated Iron Powder (AIP) Flow-Through Reactor System

A representative sequential biological denitrification and activated iron powder (AIP) flow-through reactor system and method is described below.

Activated iron powder (AIP) technology. AIP has overcome the zero-valent iron (ZVI) surface passivation issue, which has constrained the practicability of conventional ZVI technology. In the past, researchers discovered that many cations and oxyanions could be reduced during the corrosion of ZVI and then removed by iron corrosion products. However, the ZVI surface was rapidly oxidized to ferric (oxy)hydroxides and subsequently passivated so that reactions could not continue. In the AIP treatment process, aqueous Fe²⁺ is continuously added into a mixed solid suspension (ZVI/magnetite) system where magnetite exists either on the surface of ZVI particles or as discrete solids. The hybridized solids ZVI/magnetite/Fe²⁺ (AIP) exhibit a chemical reducing capability and can reduce various cations (Hg²⁺, Ni²⁻, Cu²⁺)and oxyanions (NO₃⁻, SeO₄²⁻, Cr₂O₇²⁻, MoO₄²⁻) to low ppb or even sub-ppb levels. AIP also has a high affinity for multiple ions (e.g., Cd²⁺, Pb²⁺, H₄SiO₄, AsO₄³⁻) so that they can be adsorbed or co-precipitated into AIP and removed.

ZVI is the major electron donor and provides reactive surface for reactions as well. The role of Fe²⁺ is to provide electrons and to rejuvenate the oxidized ZVI surface to overcome surface passivation. Magnetite is the final product of concurrent ZVI corrosion and surface oxidation, which also acts a reactive medium for electron transfer. The AIP water treatment technology has been successfully demonstrated in laboratory and pilot-scale field tests treating high-TDS (total dissolved solids) FGD wastewater and is capable of consistently reducing Se and Hg to below 10 ppb and 5 ppt, respectively, in a four-AIP reactor-in-series (8-12 hr HRT, 1-2 gpm flow rate) treatment system.

Despite the superior performance in reducing and removing various contaminants, one disadvantage of the AIP water treatment technology is shown in treating nitrate, a pollutant commonly found in wastewater and groundwater. Nitrate is reduced to ammonium which has to be removed in post-treatment if its concentration is too high. Moreover, although selenate has a priority over nitrate in term of chemical reduction potential by AIP, they are concurrently reduced in a flow-through operation. Nitrate usually exists at a much higher concentration than selenate does in wastewater, therefore nitrate will consume a large amount of ZVI and Fe²⁺ as formulated in Eq. 2:

NO₃⁻+2.82Fe⁰+0.75Fe²⁺+2.25H₂O→NH₄⁺+1.19Fe₃O₄+0.5OH⁻ (2)

In order to resolve the issues of ammonium production and increased chemicals consumption during nitrate treatment by the AIP technology, the present invention provides an approach that relies on the conversion of nitrate to nitrogen gas during anaerobic respiration by denitrifying bacteria. In the past, various genera of bacteria (e.g., Pseudomonas, Paracoccus, Thiobacillus, Hyphomicrobium) have been found to be able to reduce nitrate to nitrogen gas under anaerobic conditions using a variety of carbon sources. Biological denitrification has also been extensively studied and applied in wastewater treatment field. The kinetics of using methanol as carbon source in acidic-neutral environments has been investigated and proliferative genera have been identified as Hyphomicrobium and Paracoccus, and as Hydrogenophaga and Comamonas.

Pseudomonas sp. has been utilized to reduce nitrate using acetic acid with a medium-to-high denitrification rate and a relatively low biomass yield when successfully treating high-nitrate wastewater. Other researchers studied biological denitrification in the presence of different carbon sources such as glucose, acetate, glycerol, lactic acid, and ethanol. The kinetic parameters and operational parameters (e.g., carbon dosage, pH, oxidation-reduction potential) have been evaluated in different water treatment processes (anaerobic digester, biofilters).

In AIP reactors, mixed solids ZVI/magnetite/Fe²⁺ provide a reducing (negative ORP) environment and also medium for cell growth. Elemental iron and its oxides and (oxy)hydroxides widely exist in soils and minerals and the working pH of AIP is 6-9 and nearly neutral, which are hospitable to the growth of denitrifying bacteria. In the present invention, biological denitrification was introduced into the AIP treatment process to reduce nitrate to nitrogen gas, in replacement of the chemical reduction to ammonium by AIP.

In this modified system containing cells/ZVI/magnetite/Fe²⁺, nitrate can be completely reduced to nitrogen gas through biological denitrification with a priority over being reduced by the AIP process under controlled conditions, and selenate can still be removed efficiently by the AIP process without severe adverse effect from biological denitrification. The addition of biological denitrification did not trigger additional post-treatment of treated water.

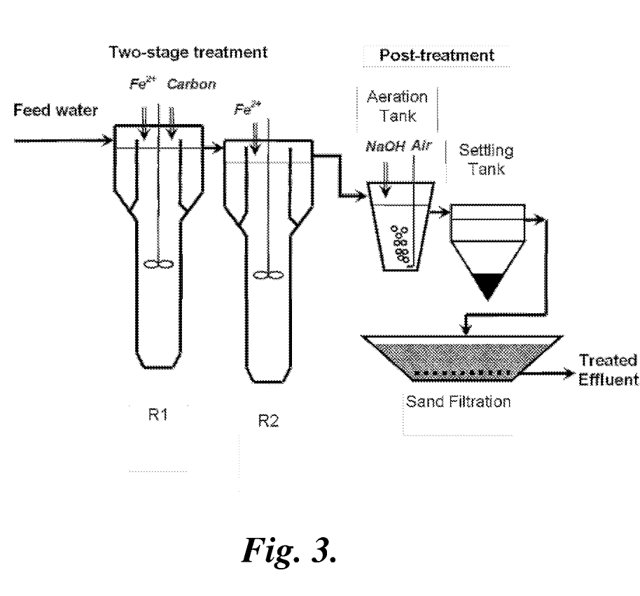

Sequential Flow-through Batch Reactors System. Two equal-size batch reactors were used in this flow-through system (FIG. 3). Feed water was pumped through the biological denitrification reactor (R1) first and then the AIP reactor (R2). R1 was lifted on an 8-inch pedestal so that effluent from R1 flowed towards R2 facilitated by gravity. Each reactor was made from steel and had a total volume of 10 liters including a 6 L inner mixing chamber and a 4 L outer settling chamber, as illustrated in FIG. 3. Each reactor was equipped with a stirrer to provide mixing in the inner chamber at an rpm of 1600. Water in the settling chamber was separated from mixing chamber and stayed still. Post-treatment included a 12 L aeration/settling tank and a 3-inch-deep sand filtration tank to remove excess Fe²⁺ and turbidity from final effluent, respectively. Two MasterFlex peristaltic digital pumps were used to provide feed water into R1 and chemical reagents such as carbon and Fe²⁺ to R1 and R2. Feed water into R1 was pumped at a flow rate of 24.5 ml/min and other reagents at a flow rate of 0.5 ml/min, which made a hydraulic retention time (HRT) of 4 h in the mixing chamber of each reactor. All HRTs mentioned in this study referred to that in the mixing chamber (6 L volume) of a reactor.

During the normal flow-through experiments after preconditioning and inoculation of denitrificans (details below), for each stage, the system was operated for at least five days until a relatively steady state was achieved (±10% variance in nitrate and selenate removal efficiency), before switched to another stage at which the type of carbon source into R1, or the ratio C to N, or Fe²⁺ dosages into R1 and R2, or pH of feed water varied. Temperature was stable within 20±2° C.

Materials. Each reactor (R1 and R2) was originally loaded with 750 g industrial grade 325-mesh zero-valent iron (ZVI) power (98% purity, Sunlight Sheds). The primary size of iron powders were 4-10 microns. Chemicals used in this study were all of analytical grade. Three types of carbon sources were examined: glacial acetic acid, methanol, glucose. They were prepared in stock solutions and supplied to R1 via pump. Ferrous chloride (FeCl₂.7H₂O) stock solution was preserved in 2 mM HCl for up to 3 days. Ultra-pure deionized water (resistivity >18 MΩ·cm, Barnstead E-pure, Thermo Scientific, USA) was used to prepare stock solutions.

For the sequential flow-through reactors system, feed water into R1 was made from synthetic groundwater spiked with elevated levels of nitrate (30 mg/L as N), selenate (3 mg/L as Se) and perchlorate (5 mg/L as ClO₄₋). Perchlorate is another widespread environmental contaminant in the States (USEPA, 1999) and was also added as an indicator of functioning biological treatment process because perchlorate can barely be removed by our AIP treatment process while research proved that perchlorate could be reduced to chloride by microorganisms. Synthetic groundwater was prepared from tap water after reverse osmosis treatment (RO water) and its composition was listed in Table 1. When the reactors system was operated under flow-through mode, 1 ml nutrient stock solution (details in Inoculation of Denitrificans) was added into 1 L feed water to support the growth of denitrificans.

TABLE 1
The composition of synthetic groundwater and
anions of elevated concentration levels.

| | Concentration level |
|---|---|
| *Synthetic groundwater Component | |
| Ca²⁺ (CaCl₂•2H₂O) | 6 mg/L |
| Mg²⁺ (MgCl₂•2H₂O) | 2 mg/L |
| SO₄²⁻ (Na₂SO₄) | 25 mg/L |
| **Cl⁻ (NaCl) | 75-105 mg/L |
| Alkalinity as HCO₃⁻ (NaHCO₃) | 150 mg/L |
| Si as SiO₂ (Na₂SiO₃) | 5 mg/L |
| **pH | 7-8.5 |
| Anions of elevated conc. levels | |
| NO₃⁻—N (NaNO₃) | 30 mg/L |
| SeO₄²⁻—Se (Na₂SeO₄) | 3 mg/L |
| ClO₄⁻ (NaClO₄) | 5 mg/L |

*the composition was slightly adapted from that of tap water in the city of College Station, Texas (Annual Drinking Water Quality Report, 2009).
**the pH value of feed water was adjusted from originally 8.5 to 7 with 6N HCl and chloride increased accordingly.

Preconditioning of ZVI powders to AIP. Before introduction of denitrificans and synthetic groundwater into the reactors system, ZVI powders in both R1 and R2 were preconditioned by pumping 2 mM nitrate through the system with a flow rate of 24.5 ml/min and 2 mM ferrous chloride with a flow rate of 0.5 ml/min. Additional 2 mM nitrate and 2 mM Fe(II) were supplied into R2 using another pump with a flow rate of 0.5 ml/min. Nitrate feed solution was made from RO water and sodium nitrate. The preconditioning (Eq. 2) took about 5 days until the surface of ZVI powders turned black form metallic grey, on which nitrate was reduced to ammonium by Fe⁰ and surface-associated Fe(II) while Fe⁰ was oxidized to lepidocrocite and then transformed into magnetite through binding of aqueous Fe(II). After preconditioning, the surface of ZVI powders was coated with a layer of magnetite and the mixed solids of Fe⁰/magnetite/Fe(II) was named activated iron powder (AlP). Nitrate and Fe²⁺ were depleted in both R1 and R2, and pH values were about 8 after 5-day preconditioning.

Control experiments were run as a sequential flow-through reactors system on R1 and R2 for around one week, after preconditioning but before denitrificans were introduced into R1. Feed water was the spiked synthetic groundwater (no nutrient) and HRT was 4 h for each reactor.

Inoculation of Denitrificans. After preconditioning and control experiments, randomly-selected 20 g soil from outdoors was mixed with 20 ml RO water. The supernatant was transferred into the mixing chamber of R1 while R1 had about a 10 L mixture of AlP and water. Daily dosages of 3.64 g NaNO₃ (30 mg/L N) and carbon source (acetic acid, methanol or glucose) at a C:N ratio of 4 were added into R1 to inoculate denitrificans for three days. During inoculation, R1 was operated under batch mode and mixed at 1000 rpm. Nutrient stock solution was made as the following recipe: one Centrum (Women Under 50) multivitamin/multimineral supplement tablet (Pfizer, USA) was dissolved in 100 mL RO water and then mixed with 0.351 g KH₂PO4. Two-ml nutrient stock solution was added into R1 per 1 L inoculum. pH in R1 was adjusted between 7-8.5 with 6N hydrochloric acid. Aqueous samples were collected from settling chamber daily and then filtered with 0.45 μm pore size hydrophilic polyethersulfone membranes for nitrate and ammonium analysis. A gas collector was installed in R1 to monitor gas production. R2 remained idle (mixing at 100 rpm and batch mode) during R1 inoculation.

After batch-mode inoculation, R1 and R2 were switched to a flow-through system. The system was fed with synthetic ground water spiked with nitrate, selenate, and perchlorate, but in a longer HRT of 8 hrs. Carbon (e.g., acetic acid) was pumped into R1 and Fe²⁺ into R2 and/or R1. This stage lasted for around two days until nitrate was 97% removed in R1. Afterwards HRT was shortened to 4 hrs and the system entered normal operating condition as a sequential flow-through biological denitrification and AlP batch reactors system. Control experiments were also conducted after introduction of denitrificans in the absence of Fe²⁺ to investigate the pathways of nitrate and selenate reduction in the system.

Sampling and Analytical Methods. At least one aqueous sample was collected daily from feed water tank and the settling chambers of R1 and R2. These samples were then filtered with 0.45 μm pore size polyethersulfone membranes for anion and cation analysis. Aqueous samples were intermittently collected from the sand filtration tank for anion analysis. pH values in feed water and the mixing chambers of R1 and R2 were daily monitored. Oxidation-reduction Potentials (ORP) and dissolved Fe²⁺ concentrations in the mixing chambers of R1 and R2 were daily measured. Protein content in both mixing and settling chambers of R1 and R2 were measured weekly. Dissolved organic carbon (DOC) in the settling tanks of R1 and R2 and in the final effluent after sand filtration was intermittently monitored. Gas collectors were installed in R1 and R2 to collect gas produced during denitrification.

Anion (nitrate, perchlorate, acetate, chloride, sulfate, nitrite) and cation (ammonium, calcium, magnesium) analyses were performed by Dionex DX500 Ion Chromatography (IC) equipped with a conductivity detector CD20 and an Ionpac AS22 or CA12 separation column. Selenium was analyzed by a Perkin Elmer DRCII Inductively Coupled Plasma-Mass Spectrometry equipped with a dynamic reaction cell (ICP-MS-DRC). Aqueous Fe²⁺ was preserved in 0.27 N HCl and then analyzed with phenanthroline method (APHA-AWWA-WEF, 2005) on a T80 UV/Vis Spectrometer (PG Instruments Ltd, UK). pH and ORP were measured with an Orion 2 star pH/ORP meter (Thermo Electron, USA). Protein content was measured using bovine serum albumin (BSA) as standard and using modified Lowry Protein Assay kit (Pierce Technology, Illinois, USA) and the results were verified using bicinchoninic acid (BCA) assay kit (compatible with reducing agent) purchased from G-Biosciences, USA. To extract protein from suspensions collected from mixing and settling chambers of R1 and R2, aliquots of suspensions were mixed with 0.1 M NaOH and heated in water bath at 90° C. for 20 min. After centrifugation at 8000 g for 20 min, the supernatant was used for protein analysis. Assuming a nitrogen to protein converter of 6.25 and cell formula of C₅H₇O₂N, biomass was calculated from the protein content measured by Lowry Assay. DOC (non-purgeable dissolved organic carbon) was analyzed by high-temperature catalytic oxidation on a Shimadzu TOC analyzer. Gas was withdrawn from the gas collector using 15-ml syringes and the composition was analyzed immediately on a SRI Multiple Gas Analyzer Gas Chromatograph equipped with an on-column injection system and a Thermal Conductivity Detector, using helium as carrier gas.

The morphology and property of solids in R1 and R2 was examined by a JEOL JSM 6400 scanning electron microscope (SEM) and by powder x-ray diffraction (XRD) equipped with a monochromatized Cu Kα radiation (D8, Bruker). Samples for SEM were filtered with 0.2 μm polyethersulfone membrane, and then fixed in 1% gluteraldehyde for 15 minutes and subsequently in 2.5% osmium overnight. The sample was dehydrated in an increasingly graded series of methanol to water and then dried in an increasingly graded series of methanol to HMDS (hexamethyldisilazane) before examined. Both backscatter and secondary images were taken at ×5000 magnification and 10 kV accelerating voltage. Samples for XRD were filtered with 0.2 μm polyethersulfone membrane, and then dried in an anaerobic chamber (filled with >3% H₂ mixed with N₂, Coy Laboratory, USA) overnight before analysis.

Results

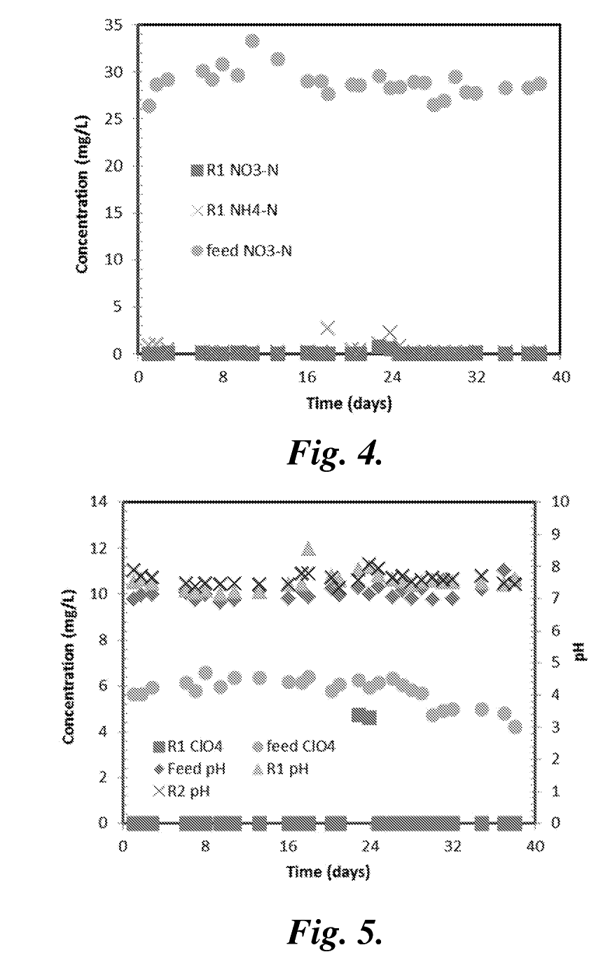

Nitrate and Perchlorate Removal. Nitrate and perchlorate were both removed by >99% and >96% in the biological denitrification reactor (R1), through biological treatment. Denitrificans quickly adapted to the ZVI/magnetite/Fe²⁺ environment in R1 after three-day inoculation, using acetic acid as carbon source. Foams and floccules were observed buoyant in the biological denitrification reactor R1. As illustrated in FIG. 4, nitrate was steadily reduced from 30±1.43 to below 0.05 mg/L N in R1 effluent. During inoculation and the first two days of the flow-through operation, up to 3 mg/L nitrite-N was detected in R1. However, it dropped to non-detectable (<0.1 mg/L N) ever since therefore nitrite accumulation had never been a concern. Ammonium was below detection limit 0.2 mg/L N most of the time. Increasing ammonium production may occur after operating conditions suddenly varied. For example, ammonium was detected high up to 2.7 mg/L N due to temporary carbon deficiency caused by worn pump tubing. Ammonium decreased to <0.2 mg/L after the tubing was fixed. The absence of ammonium during robust cell growth and the occasional ammonium production during carbon deficiency verified our hypothesis that biological reduction of nitrate took place with a priority over chemical reduction by AIP in this complex cells/ZVI/magnetite/Fe²⁺ system. Gas was collected at a relatively steady rate in R1, which was composed of 94% N₂, 2.5% O₂ and 3.5% CO₂ on average. The small amount of oxygen was possibly introduced from atmosphere during sampling and analysis. Nitrogen and carbon dioxide were both products of respiratory denitrification.

The pH value in R1 mixing chamber varied from 7.2 to 7.6 with pH in feed water ranging from 6.9 to 7.3, which agreed with previous observations on pH increase due to acidity consumption or alkalinity production during biological denitrification. During Day 18 to Day 23, carbon supply became insufficient caused by worn pump tubing, resulting in a sudden jump in pH up to 8.6 and ammonium increase up to 2.7 mg/L N in R1 (FIG. 4). Due to the lag effect of cell growth, nitrate residue in R1 did not increase from <0.1 to 0.7 mg/L N until Day 23. The pump problem was fixed on Day 23 and nitrate removal went back to normal on Day 25. pH increase was probably caused by less acidity input into R1 during carbon deficiency. The increase of ammonium might have been contributed from chemical reduction of nitrate to ammonium by AIP (ZVI/magnetite/Fe²⁺) when cell growth slowed down. Dissimilatory nitrate reduction to ammonia (DNRA) was ruled out because it usually occurred under a carbon-rich environment.

Acetic acid at a molar ratio of C to N equal to 1.4 provided sufficient carbon source to sustain cell growth and nitrate dissimilation, without resulting in excess acetic acid residue in R1 effluent. Acetate remained <0.2 mg/L in R1 effluent. DOC (non-purgeable dissolved carbon) in the R1 effluents and final effluents after post treatment was 2.4-3.8 and 2.5-3.88 mg/L, respectively, which suggested that there was little dissolved carbon residue (i.e., carbon source and biomass) in the treated water. Higher ratios of C to N, 1.45 and 1.6, caused 4.5-18.7 mg/L acetate residue (data not shown). The theoretical stoichiometric molar ratio of C to N is 1.25 for nitrate dissimilation as described in Eq. 3 and that is 1.638 for overall heterotrophic nitrate reduction including deoxygenation and cell synthesis as described in Eq. 4.

5CH₃COOH+8NO₃⁻→8HCO₃⁻+2CO₂+6H₂O+N₂ (3)

0.819CH₃COOH+NO₃⁻→0.068C₅H₇O₂N+HCO₃⁻+0.301CO₂+0.902H₂O+0.466N₂ (4)

The optimal molar ratio of C to N at 1.4 determined in our study was between these two theoretical values and also among those reference values ranging from 1.05 to 4.8 used in past practice.

Protein (BSA) content in R1 ranged from 1.04 to 2.24 g/L, during which R1 underwent cell growth, wash of solids to remove excess biomass, and cell growth again. The corresponding biomass was calculated as 1.34 to 2.89 g/L. The yield in R1 was about 0.054 g protein/day and about 0.07 g biomass/day during normal flow-through operation without accidents or interruption. The yield of biomass to NO₃—N was 0.066 (g/g) and the yield of biomass to carbon was 0.055 (g/g C), which are both lower than but still comparable with the values, 0.155 and 0.2, respectively, for denitrification by the mixture of Pseudomonas sp. and Cocci sp. in continuous-flow stirred reactors treating high-nitrate (1.4 g/L NO₃—N) industrial wastewater with an HRT ranging from 5 to 50 hrs and using acetic acid as carbon source. Growth yields of 0.53 g TSS/g acetic acid-C and 0.8 g TSS/g NO₃—N have been reported in a CSTR with an HRT=24 h treating ˜450 mg/L NO₃—N influent. Many causes might contribute to the low cell growth yield: low nitrate influent, short HRT, different medium for cell growth, or different means to measure biomass. ORP was mostly between −200 and −170 mV, which was found suitable for the growth of denitrificans. In the control experiments before denitrificans were introduced to the preconditioned AIP reactors, ORP values were about −350 mV in R1 and about −480 mV in R2, which implied that the existence of denitrificans enhanced ORP values in AIP suspension and created a less reducing aquatic environment. Chloride increased from about 100 mg/L in feed water to about 150 mg/L in R1 effluent due to FeCl₂ addition.

Perchlorate was reduced from 5 to below 0.2 ppm (IC detection limit) in R1 (FIG. 5). The high efficiency was consistent and steady except during Day 23 to 25 due to carbon deficiency. The fact that perchlorate removal was influenced as well while denitrification was inhibited suggested that perchlorate removal was correlated with microorganisms. Acetate is an electron donor that enhances perchlorate reduction by perchlorate-reducing bacteria (PRB, e.g., Dechlorospirillum sp.) and nitrate stimulates perchlorate reduction once perchlorate started to biodegrade. At the same time, most of strains of PRB are facultative anaerobic and can use nitrate as electron acceptor. Therefore PRB might constitute a small population of denitrificans in R1. Pure AIP treatment process is not capable of reducing perchlorate significantly. In the control experiments run before converting R1 to biological denitrification reactor fed with synthetic groundwater (5 ppm ClO₄⁻), perchlorate was reduced only by 5-10% in R1. In those control experiments, Fe²⁺ supply into R1 and R2 were 2.3 and 0.5 mM, respectively; the pH values in R1 and R2 ranged 7.5-8. The Fe²⁺ supply and pH range were sufficient and suitable for chemical reduction by AIP.

Without biological denitrification being involved, nitrate cannot achieve complete removal in the presence of selenate in a one-stage AIP reactor because selenate is reduced with a priority over nitrate, although selenate and nitrate are still concurrently reduced. Nitrate was reduced to about 0.03 from about 30 ppm N in R1 fed with synthetic groundwater in the absence of selenate and perchlorate. After the addition of 3 ppm selenate-Se and 5 ppm perchlorate into feed water, nitrate removal efficiency in R1 dropped to 30-50%.

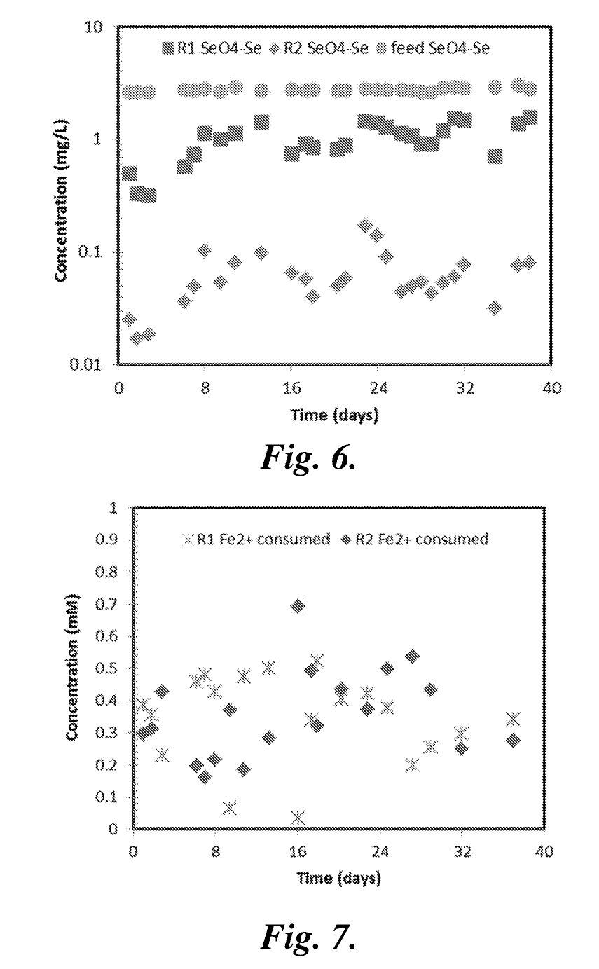

Selenate Removal. Selenate could be reduced from about 3 ppm to about 50 ppb Se after a two-stage (R1 and R2) 8-hr HRT treatment, mainly through chemical reduction by AIP. The selenate removal performance was slightly worse than that by a pure AIP treatment process with a similar HRT. In the control experiments run before conversion of preconditioned R1 to biological denitrification reactor, selenate in synthetic groundwater could be reduced from about 3 ppm to below 30 ppb after a two-stage (8-hr HRT) treatment, where selenate was removed by 76-95% in the first AIP reactor and by >95% in the second one (data not shown). FIG. 6 shows that selenate was removed by 47-87% in biological denitrification reactor R1 and by 90-95% in R2. Se removal in R1 varied widely compared to that in R2. The decreasing Se removal over time during Day 3 to 13 was caused by the accumulated biomass in R1. At Day 13, solids in R1 were washed with deionized water and biomass was disposed. Biomass in R1 mixing chamber was about 2.89 g/L and 1.34 g/L before and after wash, respectively. The reactors system went back to normal flow-through operation immediately. After one day running, selenate removal in R1 increased sharply from 48% to 73%. The inhibition on selenate removal likely resulted from the less contact of AIP with selenate ions in the presence of excess biomass so that the chemical reducing capability of AIP was weakened. The correlation between the amount of biomass and selenate removal efficiency has not been quantified. However, routine wash of AIP to remove excess biomass in R1 is necessary to achieve a low Se level (<50 ppb) in a 2-stage treatment system. pH in the R2 mixing chamber varied from 7.4 to 8 (FIG. 5) and chloride was about 180 mg/L. Biomass in R2 was 0.44-1.08 g/L and the yield was inconsistent over time (20-day average=0.017 g biomass/L). Similar to R1, R2 will inevitably undergo the reducing capability of AIP after a long-term operation, because cells were carried over from R1 effluent and biomass did accumulate at a slower rate in R2.

Selenium in the final effluents after post treatment (aeration, settling and sand filtration) varied within ±10% from R2 effluents, which agreed with results from previous field tests treating FGD wastewater using pure AIP sequential flow-through reactors system. A small part of selenium at lower oxidation states may be oxidized to selenite or selenate during aeration. In addition, selenite and selenate may adsorb to ferric hydroxide precipitates during settling and sand filtration.

One major pathway of selenate reduction in R1 and R2 was chemical reduction of selenate to elementary selenium by AIP. In the suspension of AIP, aqueous selenate and Fe²⁻ continuously contacted and/or bound to pre-existing iron oxides on ZVI surface during mixing. Selenate was reduced to selenite, selenite and then Se⁰ with electrons provided by Fe⁰ and surface-associated Fe²⁺ on ZVI, while surface-bound Fe²⁺ was oxidized to Fe³⁺and Fe⁰ in ZVI was oxidized to ferrous (hydr)oxides. The outer surface of ferric oxides was rejuvenated by continuous binding of aqueous Fe²⁺. Resultantly non-stoichiometric magnetite was formed surrounding ZVI particles with Se⁰ being contained within. In a study of selenate reduction by AIP, Se speciation in iron-based solids determined by layered sonication and digestion showed that elemental selenium was the dominant form, selenite and selenate the second, and that trace level selenide might exist.

Biological reduction of selenate by selenium-reducing bacteria and the adsorption of selenate onto iron oxides were likely the other two minor pathways. Sulfate was consistently reduced by 1-2 mg/L in R1 from feed water (about 25 mg/L) and by 1-2 mg/L in R2, which implied the possible existence of sulfate-reducing bacteria (SRB). SRB are capable of reducing selenate to elementary selenium under a reducing environment with ORP<−100 mV and of reducing sulfate to sulfide with ORP<−200 mV. With ORP values of −200 to −170 mV in R1 and those of −230 to −170 mV in R2, biological reduction of selenate possibly occurred in the reactors system. In addition, selenate was reported to slightly adsorb to magnetite and the adsorption decreased as pH increased from pH 2 to 10. In the control experiment after introduction of denitrificans into preconditioned R1 but without Fe²⁺ addition, selenate was reduced by 20-30% in R1. This 20-30% could not exclude the contribution from chemical reduction by ZVI/magnetite, because the acidity coming from acetic acid and feed water (pH=7) could be utilized by Fe⁰ to reduce selenate, as evidenced by up to 2 ppm Fe²⁺ being released into aqueous solution from the solids in Rl. In another control experiment using glucose as carbon source and using synthetic groundwater of pH about 8.5 as feed water, selenate removal in R1 was only 6-7.5% and no Fe²⁺ was released. In both controls, external Fe²⁺ was not provided and nitrate was nearly 100% removed in R1, which suggested that denitrificans functioned well. In the former, pH in R1 was ˜7.2 and ORP was about −150 mV. In the latter, pH in R1 was about 9.5 and ORP was about −200 mV. Analogically, it was assumed that those bacteria capable of reducing selenate functioned similarly under these two relatively similar conditions. The reducing capability of AIP was greatly diminished at pH >9, therefore the 6-7.5% selenate reduction in the latter might mostly result from biological reduction and/or adsorption to iron oxides or iron (oxy)hydroxides in R1, while the 20-30% selenate reduction in the former might contain a large contribution from chemical reduction by ZVI.

The sharp jump of Se in R1 effluent at Day 23 (FIG. 6) was the consequence of carbon deficiency during Day 18 to Day 23. During the period, pH in R1 increased up to 8.5 and the effect on nitrate reduction was delayed by a few days due to the lag effect of cell growth. In addition to the likely loss of biological selenate reduction by Sulfate-Reducing Bacteria due to carbon deficiency, the decrease in selenate removal was also probably caused by the increase of nitrate residue in R1 occurring from about Day 23. Nitrate existed at a high much molar concentration than selenate and consumed Fe²⁺ during insufficient cell growth, which resulted in pH increase, ammonia production and Fe²⁻ deficiency, and subsequently a decrease of selenate reduction. After carbon supply was enhanced at Day 23, selenium reduction gradually went back to the levels similar to the pre-carbon deficiency days. The slowly decreasing trend of selenate in R1 was in accordance with decreasing pH and Fe²⁺ consumption, which suggested that it took a longer time for the system alkalinity or buffer to lower back to normal conditions after five-day inactive growth of cells. In contrast, nitrate removal went back to pre-carbon deficiency levels much more rapidly. Both biological reduction by bacteria and chemical reduction by AIP are correlated with alkalinity production. It remains what mechanisms are behind these phenomena and which process between biological reduction and chemical reduction is the limiting step. Around Day 30 and 17 days after wash of biomass in R1, selenate removal gradually decreased as biomass accumulated and Se in R2 effluent accordingly increased to about 75 ppb.

Role and Consumption of Fe²⁺ and ZVI. Fe²⁺ consumption in R1 and R2 was 0.34±0.16 mM and 0.33±0.16 mM, respectively, based on data from Day 1 to Day 18 prior to carbon deficiency (FIG. 7). Compared with a pure 2-stage 8-hr HRT AIP treatment process, Fe²⁺ was saved significantly by >60% in R1 and 40% in R2. Fe²⁺ was not only consumed through reducing selenate but also through binding to iron oxides, providing acidity and buffering system pH, therefore the molar ratio of Fe²⁺ consumption to selenate reduced was not stoichiometric at 1:1 as reported in batch experiments using a simple matrix (e.g., deionized water without any alkalinity). Denitrificans might consume some Fe²⁺. First evidence is that Fe²⁺ consumption in R1 sharply dropped from 0.5 to 0.03 mM immediately after wash of solids in R1 and increased afterwards. In addition to less consumption of Fe²⁺, as shown in Eq. 1, up to 2.55 g Fe⁰ can be saved per gram of nitrate removed by biological denitrification instead of by AIP because Fe⁰ works as the major electron donor.

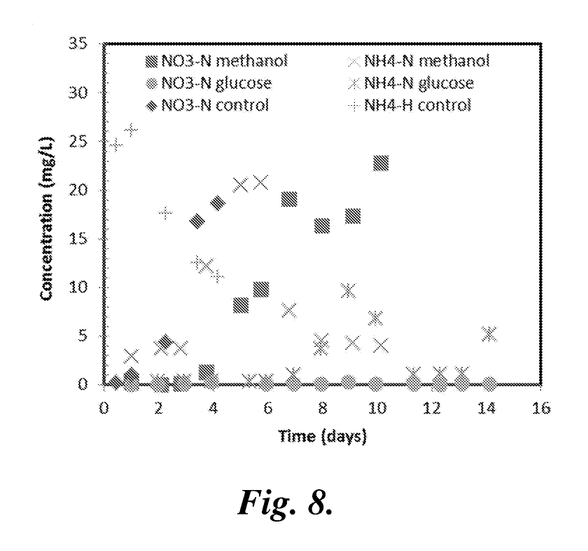

Effect of Carbon Source. Three carbon sources (acetic acid, methanol, glucose) were evaluated for optimal performance in nitrate removal and ammonium production. Acetic acid was determined as the optimal choice for carbon source regarding nitrate removal, and ammonium and pH control. Methanol was not capable of supporting the robust growth of denitrificans under the reducing environment created by AIP, although it has been proven to be a good carbon source for biological denitrification in previous research. As illustrated in FIG. 8, nitrate removal was between 30-70%, except the first four-day data right after inoculation. The high nitrate removal was the lag effect of the initial inoculation during which 50 ml whole milk was added into R1 (milk was no longer added in other inoculations) so that denitrificans grew well using carbon in milk instead of methanol. Nitrate removal was slightly better than that in control experiment without introduction of denitrificans. Ammonium production was high up to 22 mg/L N, which implied that most of nitrate was reduced to ammonium through dissimilatory nitrate reduction ammonium (DNRA) and/or through chemical reduction by AIP treatment process rather than the anticipated anaerobic respiration to nitrogen gas. Ammonium production enhanced when the molar ratio of C to N was increased from 1.5 to 4, because DNRA occurred even more commonly under a carbon-rich environment. Different from methanol, glucose as carbon source could sustain a nearly 100% nitrate removal. However, ammonia production and pH control became major concerns. At C:N=2, pH increased by 2-4 from feed water to R1 mixing chamber. When the pH in R1 increased above about 8.3, ammonium increased significantly. High pH above 9 precipitated Fe²⁺ and greatly weakened the reducing capability of AIP. Eventually selenate reduction in R1 and R2 were both significantly inhibited.

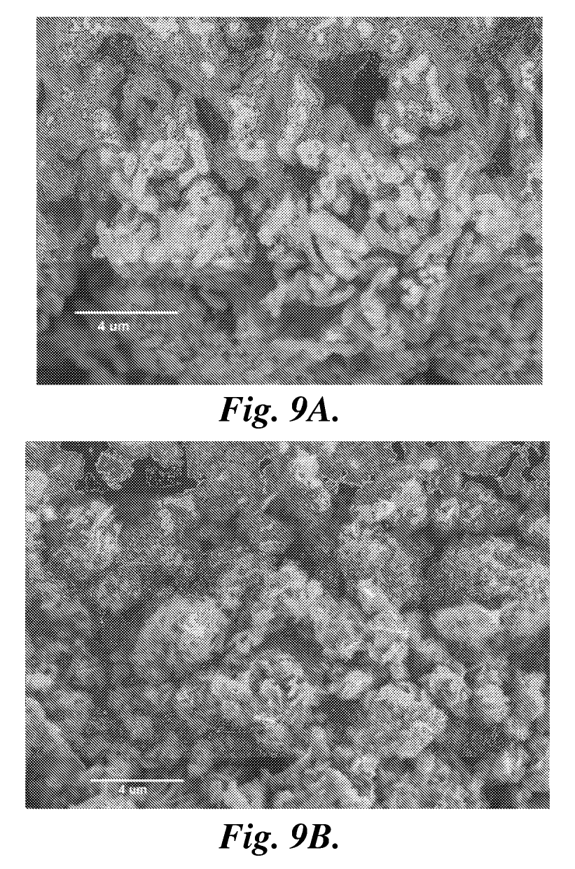

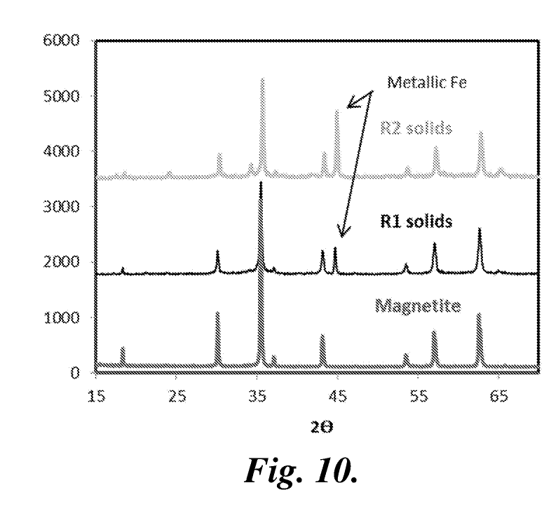

Denitrificans and Solid Morphology. At a magnitude of 5000 times, rod-shaped cells were clearly observed binding on the iron oxides in R1 and showed a darker color than iron oxides in a backscatter image, due to their smaller atomic number structures (FIG. 9A). The cells most likely belonged to Pseudomonas Denitrificans (e.g., Pseudomonas alcaligenes), which are 1-3 μm aerobes living in soils and plants but can facultatively utilize acetic acid in anaerobic respiration to reduce nitrate to elemental nitrogen and have been successfully cultivated in anaerobic reactors treating industrial high-nitrate wastewater. The poor growth of cells on methanol eliminated the prominent existence of Hyphomicrobium, the genus which has been recognized as active denitrifiers using methanol under reducing conditions. Sulfate and perchlorate-reducing bacteria might exist in small populations relative to denitrifying bacteria. The detailed taxonomy of cells requires more in-depth investigation. In contrast, darker cells were not clearly seen in the R2 backscatter image (image not shown). In the secondary SEM image of R2 solids as illustrated in FIG. 9B, the light-colored rod or needle-shaped substances on the surface of iron oxides were probably iron (oxy)hydroxides such as lepidocrocite or goethite formed during the dehydration of solid samples. Cells existed in both R1 and R2 solids, judged from their protein content. However, cells in R2 were less obvious than in R1 due to the smaller quantity. Iron oxides in R1 and R2 were characterized mainly as magnetite by XRD (FIG. 10). The large peak at 2θ=about 45° originated from Fe⁰. The morphology of iron-based solids collected from reactors R1 and R2 was consistent with our previous findings in pilot-scale field tests treating FGD wastewater using a four-stage AIP process, which suggested that chemical reduction by AIP did occur in both denitrification and AIP reactors.

Conclusion

The sequential denitrification and activated iron powder flow-through reactors system of the invention was capable of completely reducing 30 ppm nitrate-N to nitrogen gas in the denitrification reactor at neutral pH 7-8. Denitrifying bacteria adapted well into a hybridized/magnetite/Fe²⁺ reducing environment. Acetic acid was effective for the carbon source. A ratio of C:N at 1.4 supported a robust cell growth but did not raise the dissolved organic carbon residue in treated water. The system could maintain the high chemical reducing capability of AIP treatment process in the presence of denitrifying bacteria, removing selenate from 3 ppm to about 50 ppb Se after 2-stage 8-h treatment. The approach not only eliminated the production of ammonium during pure AIP treatment and its need for post-treatment, but also saved a large amount of ZVI and Fe²⁺. The biomass yield in the denitrification reactor was low, about 0.07 g/g NO₃⁻—N. Excess biomass build-up inhibited Se removal and a routine wash of solids in both denitrification and AIP reactors to remove excess biomass may be necessary to achieve a high Se removal efficiency. Nitrate was reduced completely by denitrifying bacteria and selenate was reduced mainly through chemical reduction by AIP.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for reducing the concentration of a contaminant in water, comprising contacting water comprising one or more contaminants with a zero-valent iron treatment system for a time sufficient to reduce the concentration of the contaminant in the water, wherein the treatment system comprises a combination of one or more denitrification microorganisms and a zero valent iron composite comprising
(a) a reactive solid comprising zero-valent iron and one or more iron oxide minerals in contact therewith, and
(b) ferrous iron.

2. The method of claim 1 further comprising activating the combination prior to contacting the combination with water.

3. The method of claim 2, wherein activating the combination comprises:
(a) adding a denitrification microorganism to the zero valent iron and ferrous iron;
(b) adding a nutrient for the microorganism to the combination; and
(c) incubating the combination in the presence of the nutrient for a predetermined time.

4. The method of claim 3, wherein adding the microorganism comprises adding an aqueous soil extract.

5. The method of any one of claims 1-4, wherein the microorganism is a bacterium.

6. The method of any one of claims 1-4, wherein the microorganism is an anoxic bacterium.

7. The method of any one of claims 1-4, wherein the microorganism is selected from the group consisting of Pseudomonas denitrificans, Pseudomonas aeruginosa, Pseudomonas perfectomarinus, Pseudomonas stutzeri, Pseudomonas aureofaciens, Pseudomonas mendocina, Pseudomonas fluorescens, Alcaligenes faecalis, Thiobacillus denitrificans, Paracoccos denitrificans (Micrococcus denitrificans), Microvirgula aerodenitrificans, and Thaurea mechernichensis.

8. The method of any one of claims 1-4, wherein the reactive solid is prepared by treating zero-valent iron with a solution comprising a dissolved oxidant and ferrous iron to provide a reactive solid comprising zero-valent iron and one or more iron oxide minerals in contact therewith.

9. The method of claim 8, wherein the dissolved oxidant is nitrate.

10. The method of any one of claims 1-4, wherein the reactive solid comprises a plurality of particles.

11. The method of any one of claims 1-4, wherein the one or more iron oxide minerals of the reactive solid comprise magnetite.

12. The method of any one of claims 1-4, wherein the contaminant is selected from the group consisting of a metal compound, metal ion, metalloid, oxyanion, chlorinated organic compound, or a combination thereof.

13. The method of any one of claims 1-4, wherein the contaminant is selected from the group consisting of an arsenic compound, an aluminum compound, an antimony compound, a beryllium compound, a mercury compound, a selenium compound, a cobalt compound, a lead compound, a cadmium compound, a chromium compound, a silver compound, a zinc compound, a nickel compound, a molybdenum compound, a thallium compound, a vanadium compound, an arsenic ion, an aluminum ion, an antimony ion, a beryllium ion, a mercury ion, a selenium ion, a cobalt ion, a lead ion, a cadmium ion, a chromium ion, a silver ion, a zinc ion, a nickel ion, a molybdenum ion, a thallium ion, a vanadium ion, borates, nitrates, bromates, iodates, periodates, trichloroethylene, dissolved silica, and combinations thereof.

14. The method of any one of claims 1-4, wherein the contaminant is nitrate.

15. The method of any one of claims 1-4, wherein the contaminant is a selenium compound or a selenium ion.

16. The method of any one of claims 1-4, wherein the contaminant is a selenium species are selected from the group consisting of selenate (Se⁶⁺), selenite (Se⁴⁺), and selenide (Se⁻²) species, and mixtures thereof.

17. The method of any one of claims 1-4, wherein the contaminant is a selenium species are selected from the group consisting of a selenate, a selenite, selenocyanate, selenomethionine, and methylselenic acid.

18. The method of any one of claims 1-4, wherein the water comprising one or more contaminants is selected from flue gas desulfurization wastewater, industrial waste stream, oil refinery waste, tail water of a mining operation, stripped sour water, surface water, ground water, and an influent stream.

19. The method of any one of claims 1-4, wherein the water comprising one or more contaminants is flue gas desulfurization wastewater.

20. The method of any one of claims 1-4, wherein the water comprising one or more contaminants contacts the combination in a fluidized bed reactor.

21. The method of any one of claims 1-4, wherein the denitrification microorganism is attached to the zero valent iron.

22. A zero-valent iron treatment system for reducing the concentration of a contaminant in a fluid, the system comprising a combination of one or more denitrification microorganisms and a zero valent iron composite comprising
(a) a reactive solid comprising zero-valent iron and one or more iron oxide minerals in contact therewith, and
(b) ferrous iron.

23. The system of claim 22, wherein the reactive solid comprises a plurality of particles.

24. The system of claim 22, wherein the one or more iron oxide minerals of the reactive solid comprise magnetite.

25. The system of claim 22, wherein the iron oxide is an added iron oxide.

26. The system of any one of claims 22-25, wherein the reactive solid is prepared by treating zero-valent iron with a solution comprising a dissolved oxidant and ferrous iron to provide a reactive solid comprising zero-valent iron and one or more iron oxide minerals in contact therewith.

27. The system of claim 26, wherein the dissolved oxidant is nitrate.

28. The system of any one of claims 22-25, wherein the microorganism is a bacterium.

29. The system of any one of claims 22-25, wherein the microorganism is an anoxic bacterium.

30. The system of any one of claims 22-25, wherein the microorganism is selected from the group consisting of Pseudomonas denitrificans, Pseudomonas aeruginosa, Pseudomonas perfectomarinus, Pseudomonas stutzeri, Pseudomonas aureofaciens, Pseudomonas mendocina, Pseudomonas fluorescens, Alcaligenes faecalis, Thiobacillus denitrificans, Paracoccos denitrificans (Micrococcus denitrificans), Microvirgula aerodenitrificans, and Thaurea mechernichensis.

31. The system of any one of claims 22-25 further comprising a nutrient for the microorganism.

32. The system of claim 31, wherein the nutrient is a carbon-containing material, a phosphorus-containing material, a nitrogen-containing material, or a mixture thereof.

33. The system of any one of claims 22-25, wherein the system is contained within a fluidized bed reactor.

34. The system of any one of claims 22-25, wherein the denitrification microorganism is attached to the zero valent iron.
